(19) United States
(12) Patent Application Publication
(10) Pub. No.: US 2020/0036792 A1
(43) Pub. Date: Jan. 30, 2020

(54) LOW ENERGY SENSOR DATA COLLECTION

(71) Applicant: Nokia Technologies Oy, Espoo (FI)

(72) Inventors: Arto PALIN, Akaa (FI); Teemu SAVOLAINEN, Nokia (FI); Jukka REUNAMÄKI, Tampere (FI)

(21) Appl. No.: 16/491,158

(22) PCT Filed: Mar. 28, 2017
(86) PCT No.: PCT/US2017/024489

§ 371 Date: Sep. 4, 2019

(51) Int. Cl. H04L 29/08; H04W 4/38; H04W 12/06; H04W 4/70; H04W 8/00; H04W 88/16

(52) U.S. Cl. CPC H04L 67/12; H04W 4/38; H04L 67/02; H04W 88/16; H04W 4/70; H04W 8/005; H04W 12/06

(57) ABSTRACT

Methods and apparatus, including computer program products, are provided low energy sensor data collection. In some example embodiments, there may be provided a method including sending an advertisement including a payload and an indicator identifying a server, the payload including data collected, generated, and/or measured by a sensor; receiving, from a gateway and the server, a reply including server data; and inhibiting, based on the received reply, the advertisement including the payload from being resent. Related systems, methods, and articles of manufacture are also described.

The subject matter described herein relates to sensors including wireless Internet of Things sensors.

### BACKGROUND

As sensors such as Internet of Things (IoT) sensors continue to be deployed, the quantity of these IoT sensors will grow dramatically, perhaps into the billions of IoT sensors globally. Some of these IoT sensors may be fixed, while some of these IoT sensors may be mobile. Some IoT sensors may measure inanimate objects, such as measure wear-and-tear of an object, measure weather conditions, detect traffic, and/or the like, while some IoT sensors may be used to measure living organisms, such as perform fitness or health measurements on a human or animal.

### SUMMARY

Methods and apparatus, including computer program products, are provided low energy sensor data collection.

In some example embodiments, there may be provided a method including sending an advertisement including a payload and an indicator identifying a server, the payload including data collected, generated, and/or measured by a sensor; receiving, from a gateway and the server, a reply including server data; and inhibiting, based on the received reply, the advertisement including the payload from being resent.

In some variations, one or more of the features disclosed herein including the following features can optionally be included in any feasible combination. A scan request may be received from the gateway, and in response to the received scan request, scanning for the reply being resent by the gateway. The data may include an identifier of the apparatus and/or a challenge for the server. The indicator may include a location of the server, an address of the server, a fully qualified domain name of the server, an internet protocol address of the server, and/or a uniform resource locator of the server. The advertisement may be resent until the reply including the server data authenticates the server, wherein the advertisement comprises a Bluetooth advertisement, a Bluetooth low energy advertisement, a Bluetooth scan response, and/or a Bluetooth low energy scan response. The advertisement may be sent as a broadcast and/or a multicast to the gateway via at least a Bluetooth transceiver and/or Bluetooth low energy transceiver. The payload may be encrypted, and wherein the server data included in the reply is encrypted. In response to the received reply, the data may be marked as being successfully sent to the server. The received reply may be validated based on a decryption of the payload and/or a content of the payload, and in response to the validation, inhibiting the advertisement including the payload from being resent by the sensor. The server may include a cloud server. The sensor may include an internet of things sensor, which may be used to at least perform the sending, receiving, inhibiting, and/or the like. The advertisement may be sent to a mesh network including the gateway.

In some example embodiments, there may be provided a method including receiving, from a sensor, an advertisement including a payload and an identifier identifying a server, the payload including data collected, generated, and/or measured by the sensor; forwarding, to the server, the encrypted payload; receiving, from the server and in response to the forwarded payload, a reply including server data; and forwarding, towards the sensor, the reply to enable the sensor to inhibit retransmission of the advertisement including the payload.

In some variations, one or more of the features disclosed herein including the following features can optionally be included in any feasible combination. A scan request may be sent to the sensor to enable the sensor to trigger scanning for the reply being forwarded by the apparatus. The data may include an identifier of the apparatus and/or a challenge for the server. The indicator may include a location of the server, an address of the server, a fully qualified domain name of the server, an internet protocol address of the server, and/or a uniform resource locator of the server. Retransmissions of the advertisement may be received until the reply including the server data is sent to the sensor to enable the sensor to authenticate the server, wherein the advertisement comprises a Bluetooth advertisement, a Bluetooth low energy advertisement, a Bluetooth scan response, and/or a Bluetooth low energy scan response. The advertisement and/or the forwarded reply may include a broadcast and/or a multicast to the gateway via at least a Bluetooth and/or Bluetooth low energy transceiver. The payload may be encrypted, and wherein the server data included in the reply is encrypted. The server may include a cloud server. A gateway may perform at least the receiving, forwarding, and/or the like, and the gateway may interface, via a Bluetooth transceiver and/or a Bluetooth low energy transceiver, the sensor, wherein the sensor interfaces the server via at least the Internet. A mesh network may be coupled to, wherein the mesh network enables receipt, from the sensor, of the advertisement and/or forwarding, to the server, of the encrypted payload.

In some example embodiments, there may be provided a method including receiving, from a gateway, a message including a payload, the payload including data collected, generated, and/or measured by a sensor; generating a reply including server data to enable the sensor to inhibit, based on the reply, retransmission of the advertisement including the payload; and sending, to the gateway, the generated reply.

In some variations, one or more of the features disclosed herein including the following features can optionally be included in any feasible combination. The message may be received as a hypertext transfer protocol post and/or a hypertext transfer protocol secure post. The generating may further include determining a response to a challenge provided by the sensor via the payload. The payload may be encrypted, and wherein the determined response to the challenge is included in the reply and encrypted. A cloud server may be used to perform the receiving, generating, sending, and/or the like. The sensor may include an internet of things sensor including a Bluetooth transceiver and/or a Bluetooth low energy transceiver enabling transmission the payload to the apparatus via a gateway.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example of a system for low energy sensor data collection, in accordance with some example embodiments;

FIG. 2 depicts an example of a signaling diagram for low energy sensor data collection, in accordance with some example embodiments;

FIG. 3 depicts an example of a system including a mesh network to enable low energy sensor data collection, in accordance with some example embodiments;

FIG. 4 depicts an example of an apparatus, in accordance with some example embodiments.

Like labels are used to refer to same or similar items in the drawings.

### DETAILED DESCRIPTION

IoT sensors may be configured to, for example, perform measurements and/or wirelessly transmit data to a server, such as a centralized, cloud server coupled to the Internet, to enable further processing including analysis, storage, and/or the like. For example, the IoT sensor may represent a health and/or fitness device measuring various aspects of a wearer. In this example, the sensor may need to transmit data, such as measurements collected by the IoT sensor, to other devices including a corresponding server such as a cloud server accessible via the Internet or other network. As the IoT sensor may be configured to operate using a low, or limited, power source such as a battery, solar, and/or the like, the IoT sensor may need to transmit its data (and/or receive data) in a power efficient way.

The efficient transmission by the IoT sensor may be a rather complex issue as it may need to take into account a variety of factors including size, power, link costs, and/or the like. This efficient power operation may be made even more difficult in the case of the provisioning the IoT and deployment of the IoT sensor to enable for example mobility and/or network access, authentications, and/or the like. In the case of provisioning, the network may need to authenticate the IoT sensor and/or provision the IoT sensor with for example access network credentials to allow the IoT sensor to have access to the network. This may enable the IoT sensor to obtain an uplink data path to an IoT gateway that can forward data, such as IoT sensor data, to the cloud server, and to obtain a downlink data path to receive acknowledgements and/or commands from the cloud server back to the IoT sensor. In the case of mobility, the IoT sensor may be mobile within a city, a country, and/or among countries calling into play challenges with respect to power efficient transmit/receive operation due to interoperability among network operators and/or manufacturers. In some instances, the IoT sensor may implement a low energy radio technology such as Bluetooth or Bluetooth Low Energy (LE), but even with these radio technologies the IoT sensor may be configured to repeatedly broadcast data to other, often unknown, devices. These repeated broadcasts not only represent inefficient power transmission but also inefficiently use limited spectrum resources. In view of the foregoing, there is a need to deploy IoT sensors, gateways, and/or corresponding cloud servers so that power efficient transmission and reception is provided.

In some example embodiments, an IoT sensor may wirelessly transmit, via a low power radio technology, an advertisement including an encrypted data payload and a destination address (for example, a URL indicating the location or destination address of a cloud server associated with the IoT sensor) to one or more undetected, untrusted, and/or unauthenticated IoT gateways to enable delivery to a remote server, such as a cloud server. The encrypted payload may include data collected, measured, or generated by the IoT sensor; examples of this data may include IoT sensor measurement data performed or collected by the IoT sensor and being forwarded to the cloud server, although any other type of data may be used as well. The IoT sensor may retransmit the advertisement including the encrypted payload and URL from time-to-time (for example, periodically, aperiodically, and/or the like) until at least one of the IoT gateways returns a reply, such as an authenticated reply and/or an encrypted reply, from the cloud server (which may be at the destination URL associated with the IoT sensor). The IoT sensor may then stop this retransmission when this encrypted reply is received—enabling thus the IoT sensor to save power and/or indicate (for example, to user equipment) that the data flow to the cloud server is successful.

In some example embodiments, the IoT sensor may transmit the advertisement including the URL and the encrypted payload to the gateways as a broadcast and/or an IP multicast.

Although some of the example embodiments describe the payload as being encrypted, some embodiments may not include an encrypted payload. In the case of an unencrypted payload, a challenge (to which only the cloud server can provide an accurate response) may be used. When the IoT sensor receives the cloud server's response, the IoT sensor may trust that its data has been passed to the intended cloud server, in which case the IoT sensor may stop retransmitting and/or re-broadcasting the advertisement message including the encrypted payload. Alternatively or additionally, a replay protection mechanism may be provided, so that when the IoT sensor sends to the cloud server the same measurement again, the overall messages may be different (for example, by including a random nonce in the encrypted payload) to prevent replay attacks.

In some example embodiments, the low power radio technology used to transmit and/or receive to an IoT gateway may include Bluetooth and/or Bluetooth LE, although other lower power radio technologies may be used as well. For example, the IoT sensor may broadcast the advertisement via its wireless transceiver, such as a Bluetooth transceiver, Bluetooth Low Energy (LE) transceiver, and/or the like. To illustrate further, the IoT sensor may broadcast a first Bluetooth LE advertisement message including the URL and the encrypted payload. In the case of Bluetooth LE, the advertisement message may comprise a Bluetooth LE advertisement packet, such as a Bluetooth LE advertisement packet data unit (PDU), transmitted via a Bluetooth LE advertisement channel, such as via channels 37, 28, and 39 in accordance with the Bluetooth 5.0 standard, for example. Alternatively or additionally, the IoT sensor may perform a broadcast transmission using one or more Bluetooth LE scan response PDUs (which may be sent in response to a scan request message sent by the Bluetooth LE gateway). Alternatively or additionally, a data link can be used to deliver the actual data. The gateway may form a connection with an IoT sensor device. This connection may be initiated by the gateway or the IoT sensor side (which may depend on the authentication process). In some example embodiments, Bluetooth LE General Attribute profile (GATT) may deliver data as service characteristics. The data link may be setup after a successful advertisement/scan response procedure in response to the existence and/or authenticated cloud server is confirmed.

When the IoT gateway receives an advertisement including the URL and encrypted payload from an IoT sensor, the IoT gateway may, in accordance with some example embodiments, post the encrypted data payload to the URL provided in the advertisement. In some example embodiments, the IoT gateway may send a scan request to the IoT sensor, which may trigger the IoT sensor to transmit to the IoT gateway a scan response including the URL and encrypted payload. When this is the case, the IoT gateway may, in accordance with some example embodiments, post the encrypted data payload to the URL provided in the scan response. The URL and/or the encrypted payload may be posted partly in the advertisement and partly in the scan response. For example, the URL can be posted in the advertisement and the encrypted payload can be posted in the scan response, or the continuation of the encrypted payload started in the advertisement can be posted in the scan response. The communications between the gateway and the responding cloud server may be encrypted as well. In response to the post to the cloud server, the gateway may receive a reply from the cloud server's URL. This reply may include an encrypted payload generated by the cloud server. The IoT gateway may then provide the reply, as noted above, to the IoT sensor using an advertisement, such as Bluetooth LE advertisement or a scan response. When the IoT sensor receives this reply, the IoT sensor may then stop the repeated retransmissions of the advertisements including the data in the initial transmission to the IoT gateway and cloud server.

In some example embodiments, the IoT sensor may determine, from the reply provided by the cloud server via the IoT gateway, that the cloud server has successfully received the IoT sensor's data such as a measurement packet or other type of data. This reply may thus serve as an acknowledgement enabling the IoT sensor to mark the data packets as being successfully transmitted and received by the cloud server, which can reduce (or stop) retransmission of the data (at least until there is additional data such as measurements to send to the cloud server).

In some example embodiments, the IoT sensor may initiate a scan based on the start(s) of the IoT gateway's broadcast transmission of the advertisements or the IoT gateway's transmission of a scan request. Moreover, the IoT sensor may know address of the gateway, so that when the IoT sensor receives a scan request from the gateway, the IoT sensor knows that the IoT gateway has received the advertisement. As such, the IoT sensor may whitelist the gateway, so that the IoT sensor only processes responses from the gateway, in accordance with some example embodiments.

To illustrate further, the IoT sensor device may transmit data packets via for example a Bluetooth transceiver (which may in accordance with the Bluetooth version 5 specification or subsequent additions and/or revisions thereto) to enable higher speed, when compared to Bluetooth LE version 4. But when triggering a scan, the IoT sensor may use legacy Bluetooth LE packets (for example, version 4), although version 5 or other versions in accordance with the Bluetooth LE may be used as well.

Although some of the examples describe using the scan response to carry data, other messages including a scan request message (extended and configured to carry data) may carry data. When this is the case, the gateway may provide the reply (which may include the encrypted payload) to the sensor in a scan request, which may avoid the need for the sensor to perform a scan.

In some example embodiments, the IoT sensor may establish an unauthenticated Bluetooth connection to a gateway, send the encrypted data and URL to the gateway to enable the gateway to post to the URL. Here, the sensor may wait for the reply from the cloud server, such as an encrypted reply packet over the Bluetooth connection to arrive.

In some example embodiments, a gateway may be configured to post data from any IoT sensor to any URL corresponding to a cloud server. While in other embodiments, the gateway may post data only to certain URLs that the gateway has on an allowed URL list for example. When this is the case, the gateway may ignore packets that need to be posted to URL that are not allowed (for example, not on the allowed URL list). In some example embodiments, a gateway may be configured to post data from only certain IoT sensors, such as sensors on a whitelist of allowed IoT sensors.

In some example embodiments, a gateway may require packets from IoT sensors to be correctly authenticated (for example, with an indication that the sensor knows a secret that only allowed devices ought to know). In this example, the gateway may forward data from only those IoT sensors that are authenticated. The gateway may include one or more other policy rules that determine whether the gateway is allowed to forward data to a given URL identifying a cloud server. These policies may be configured by the network, sensor, cloud server, and/or other devices as well.

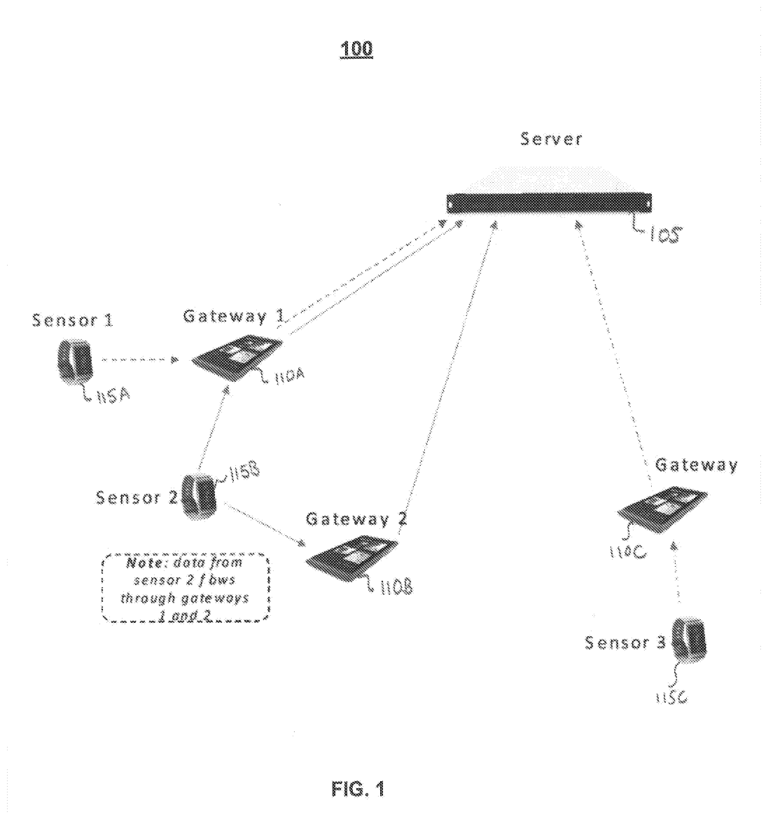

FIG. 1 depicts an example of a system 100, in accordance with some example embodiments.

The system 100 may include at least one server 105, such as a cloud server. The system 100 may include at least one IoT sensor 115A-C configured to wirelessly couple to at least one gateway 110A-C.

The IoT sensors 115A-C may include at least one processor and at least one memory including program code which may cause the IoT sensor to perform operations as disclosed herein. The IoT sensor 115A-C may include at least one wireless transceiver configured in accordance with at least Bluetooth, Bluetooth LE, and/or other wireless access technologies. In some example embodiments, the IoT sensor 115A-C may include a multi-mode wireless transceiver configured to operate in accordance with Bluetooth and Bluetooth LE. Alternatively or additionally, the IoT sensor 115A-C may have a constrained power source, such as a battery, a solar panel, and/or the like. In the case of the battery, the power source may be rechargeable. Alternatively or additionally, the IoT sensor 115A-C may have a user interface, such as a display, a touch screen, and/or other interface mechanisms (for example, physical buttons, knobs, and/or the like).

The gateways 110A-C may include at least one processor and at least one memory including program code which may cause the gateways to perform operations as disclosed herein. The gateways 110A-C may include at least one wireless transceiver. For example, the IoT gateway's wireless transceiver may be configured in accordance with at least Bluetooth, Bluetooth LE, and/or other wireless access technologies in order to communicate with the IoT sensors, and the IoT gateway's wireless transceiver may be configured with other access technologies, such as a cellular radio access technology (for example, LTE, 4G, 5G, and/or other radio access technology) and/or WiFi in order to send data to and/or receive data from server 105.

To illustrate further, the IoT gateway 110A may comprise a user equipment, such as a smart phone, cellular phone, tablet, and/or any other type of radio-based device, operating as a gateway to and/or from the cloud server 105 via a wireless access point (for example, a WiFi access point) and/or a cellular base station. Alternatively or additionally, the gateway 110A may comprise a dedicated a wireless access point (for example, a WiFi access point) and/or a cellular base station configured to send data to or receiving data from the Internet accessible cloud server 105. In some example embodiments, the gateways 110A-C may have greater capability with respect to power availability, processor performance, and/or available memory, when compared to the more limited IoT sensors 115A-C.

The cloud server 105 may receive, via an IoT gateway, the data such as data measured by an IoT sensor such as IoT sensor 115A. The cloud server 105 may be associated with the IoT sensor. For example, the IoT sensor 115A may measure the health and/or fitness of a wearer. In this example, the IoT sensor 115A may have an associated cloud server 105 (which may include a database and/or a database management system) that collects and processes the IoT sensor's health/fitness measurement data. This cloud server 105 may acknowledge receipt of the IoT sensor data. Alternatively or additionally, this acknowledgement may be provided if the IoT sensor 115A is authenticated (for example, a valid or registered user of the services provided by the cloud server 105). Alternatively or additionally, the cloud server 105 may respond to the IoT sensor 115A with data, such as commands, configuration information, software updates, analytics, graphical user interfaces, alerts, reports, and/or other information.

In the example of FIG. 1, gateways 110A and gateway 110B are within range of IoT sensor 115B, so the gateways 110A-B can receive data from sensor 115B. Moreover, gateway 110A and/or gateway 110B can forward data to (or receive data from) the cloud server 105, in accordance with some example embodiments.

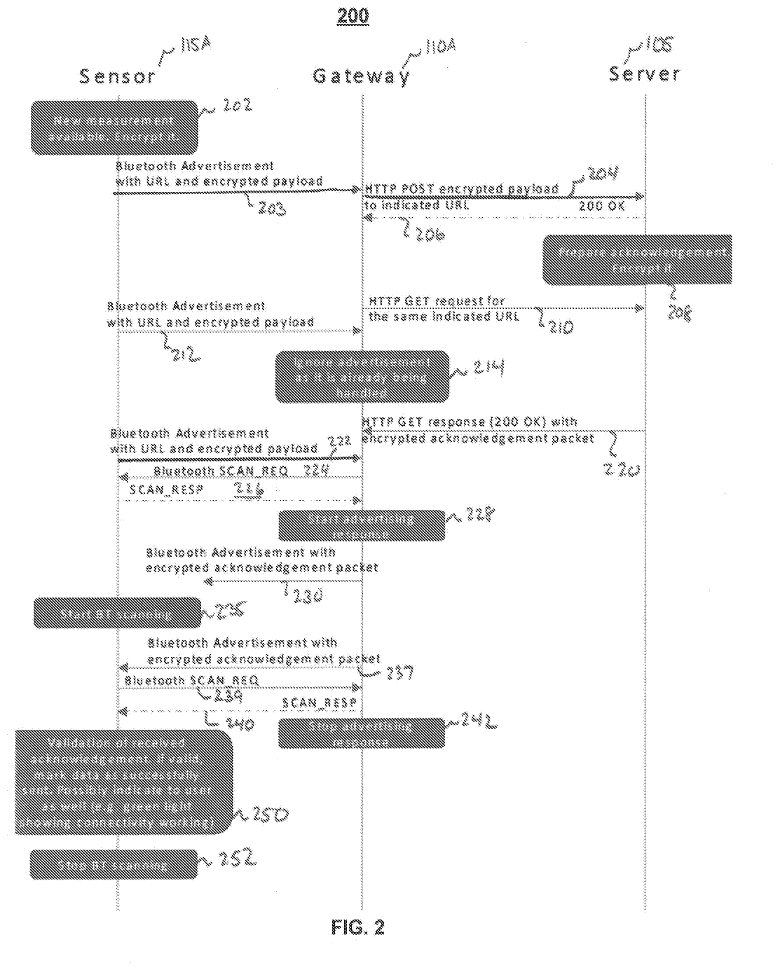

FIG. 2 depicts an example of a process 200 for IoT sensor data collection, in accordance with some example embodiments.

As noted, the IoT sensor 115A may broadcast the Bluetooth LE advertisement, which may include an indicator, such as the URL, indicating where (for example, location) to post and an encrypted payload. When the gateway 110A receives this advertisement, the gateway may then post (for example, send a message request) to the cloud server 105 the encrypted data via for example the hypertext transfer protocol (HTTP), HTTP secure (for example, HTTP over secure sockets layer or transport layer security), MQ Telemetry Transport (see, for example, MQTT specification 3.1.1), or the Constrained Application Protocol Secure (CoAPs). The cloud server may then parse the URL and determine if the received data needs to be sent to another device, such as another cloud server or a destination cloud server. When the data is at the destination server 105, this destination server may decrypt the data and prepare a reply such as an encrypted reply as an acknowledgement of successful receipt of the IoT sensor's data (and/or other data for the IoT sensor such as other commands and/or the like). The gateway may download this reply message, and then the gateway may provide the reply to the IoT sensor using, for example Bluetooth LE advertisement message(s). If the IoT sensor has moved and thus misses the gateway's reply from the server, the IoT sensor may continue/retrigger broadcasting advertisements so that another gateway can then forward the advertisement to the cloud server. When that is the case, the cloud server may resend the reply to the other gateway to enable the reply to make it successfully back to the traverse that time all the way back to the sensor.

At 202, the IoT sensor 115A may have data, such as measurement data and/or other types of data, to send to the cloud server 105, in accordance with some example embodiments. When this is the case, the IoT sensor 115A may encrypt the data to be transmitted. The advertisement's payload may be encrypted in accordance with for example an encryption standard, such as RSA, AES, AES-CTR, and/or other protocols. When using RSA encryption for example, a data payload (which may be smaller than the encryption key) may be encrypted with the cloud server's public key and then sent as an advertisement. At the cloud server, the cloud server may decrypt the payload using the cloud server's private key. If the data volumes are larger, AES-based encryption, such as AES-CTR, may be more appropriate, although other encryption standards may be used as well.

At 203, the IoT sensor 115A may send an advertisement message including, as payload, a URL and the encrypted data, in accordance with some example embodiments. The advertisement may be in accordance with Bluetooth LE, although other radio technologies may be used as well. In the case of Bluetooth LE, the IoT sensor may broadcast the advertisement via at least one advertisement channel (although in the case of Bluetooth LE, 3 channels may be used). The URL may identify the location of the IoT sensor's 115A cloud server 105. For example, the URL may take the form of Nokia.com\IOTserver or imps://iot.nokia.com/id=12345. Although the previous example refers to a URL, the destination address or location of the cloud server may be implemented in other ways as well.

At 204, the IoT gateway 110A may send a request message, such as an HTTP post including the encrypted data, to the URL, in accordance with some example embodiments. For example, the gateway 110A may receive the advertisement received at 203, and then choose to perform the HTTP (or HTTPS) post of the encrypted data to the URL where the cloud server 105 is located. In response to the post, the gateway 110A may receive, at 206, an acknowledgment indicating the HTTP post at 204 was successfully received by the cloud server 105, in accordance with some example embodiments. For example, the cloud server may respond at 206 with a successful receipt indication such as status code 200, okay. At 206, the reply may indicate a successful post but not carry a responsive payload as in 220 described below. However, in some example embodiments, the reply at 206 may not be sent until a responsive payload is generated at 208 (in which case the responsive payload would be sent at 220).

At 208, the cloud server 105 may prepare an acknowledgement to the IoT sensor 115A, in accordance with some example embodiments. For example, the cloud server 105 may decrypt the encrypted data received at 204, and may determine whether the IoT sensor 115A is a sensor that it should be communicating with (for example, is the IoT sensor registered, authenticated, and/or authorized to access the cloud server 105). If so, the cloud server may generate a response comprising an acknowledgement and encrypt that response at 208. The acknowledgement serving a responsive reply at 220 to the IoT device may be implemented in a variety of ways. For example, the acknowledgement may be a response to challenge contained in the payload of 204. In a challenge-response approach, the encrypted payload (which is received at 204) may include an IoT device identifier (for example, id=12345). The cloud server may use this identifier to identify the IoT sensor's 115A public key (and/or other data). The cloud server may then use at least the IoT sensor's public key to decrypt the payload provided at 204.

In some example embodiments, the cloud server 105 and IoT sensor 115A may each share a secret, such as a password, a shared secret key, and/or the like. When this is the case, the sensor 115A may generate and send a challenge such as a password, a key, or a signed certificate at 203-204 to the cloud server 105. If the cloud server 105 determines that the password, key, or signed certificate is correct/authentic, the cloud server may then reply at 220 and 230. Alternatively or additionally, the IoT sensor and cloud server may each possess each other's digital certificates such as an X.509 digital certificate used for authentication and/or encryption.

At 210, the gateway 110A may perform from time to time additional HTTP get requests to the same URL, in accordance with some example embodiments. In some instances, the cloud server 105 may ignore or reject these additional requests until it is ready to respond to the post received at 204.

At 212, the IoT sensor 115A may send from time-to-time other advertisement messages including the encrypted data to the URL, in accordance with some example embodiments. However, the gateway 110A may, at 214, ignore the additional advertisement messages from the IoT sensor 115A to the same URL as the gateway 110A is already in the process of handling the request to the URL.

At 220, the IoT gateway 110A may receive a reply, in accordance with some example embodiments. This response may comprise an encrypted payload which may include an acknowledgement packet to the IoT sensor 115A. In the case of HTTP, the acknowledgement packet may include a status code such as 200 (which indicates okay).

At 222, the IoT gateway 110A may receive another advertisement message as noted at 203 and 212, but the gateway may ignore the message 222 and/or may send, at 224, a scan request message to the sensor 110A, in accordance with some example embodiments. In response, the IoT sensor may acknowledge the scan request by sending, at 226, a scan response, in accordance with some example embodiments. The scan request at 224 may indicate to the IoT sensor 115A that the IoT sensor's request has been served, so the IoT sensor should start listening for messages such as advertisement messages (which include server 105's response) from the gateway. For example, the IoT sensor may be configured to not listen for any advertisements until it receives a scan request. When the IoT sensor 115A receives the scan request, the IoT sensor may then start listening for advertisements from the gateway such as 230. In this way, the IoT sensor can save power by only listening for advertisements from the gateway 110A when it receives the scan request at 224 indicating that the gateway 110A has a response from the server ready (such as the response received at 220 which is then sent after the scan request at 230). As noted above, the IoT sensor may know address of the gateway, so that when the IoT sensor receives a scan request at 224 from the gateway, the IoT sensor knows that the IoT gateway has received the advertisement. As such, the IoT sensor may whitelist the gateway, so that the IoT sensor only processes responses from the gateway, in accordance with some example embodiments.

Although FIG. 2 depicts the gateway 110A sending, at 224, a scan request message to the sensor 110A in response to the advertisement message 222, the gateway 110A may send, at 224, the scan request when it has a reply from the cloud server awaiting transmission to the IoT sensor.

In some example embodiments, the gateway may provide a reply to the IoT sensor by controlling the content of the scan response packet. The scan response (SCAN_RESP) packet can contain the address of the intended receiver (for example, the IoT sensor) of the scan response packet (for example, advertiser address (AdvA) and the address of the scan response submitter device such as the gateway's scanners address (ScanA)). Because one intention of the scan response is to provide status information to the sensor, there may be no necessary scan response needed for receipt by the gateway. As such, the gateway may alter the ScanA field in such manner that IoT sensor can detect this alteration of the ScanA field. For example, the scan request with ScanA like AdvA may indicate a successfully received advertisement, and ScanA with AdvA plus 1, for example, may indicate that scanner has information for the advertiser such as the IoT sensor. Alternatively or additionally, this ScanA may be a hash that is created from AdvA in a certain way, which may provide an. acknowledgement from the cloud server. In this example, the addition sensor does not need to trigger for every scan request packets but only those that are used for this purpose.

At 228 and 230, the IoT gateway 110A may initiate advertising in order to provide the reply received from the server 105, in accordance with some example embodiments. For example, the gateway 110A may send an advertisement message with an encrypted payload comprising the reply received at 220 from the server 105. In the case of Bluetooth LE, the gateway 110A may send the advertisement at 230 via three designated channels for carrying advertisements. The encrypted payload comprising the reply received at 220 from the server 105 enable the IoT sensor to authenticate the cloud server as being the intended recipient of the IoT sensor's data (as well as the establishment of a path to the cloud server).

As shown at 235 and 237, if the IoT sensor 115A is not scanning, the gateway 110 may need to resend, at 237, the advertisements including an encrypted payload comprising the reply received at 220 from the server 105, in accordance with some example embodiments.

At 239, the gateway 110A may receive a scan request from the IoT sensor 115A, in accordance with some example embodiments. In response to the scan request at 239, the gateway 110 may send a Bluetooth LE scan response at 240 including the encrypted payload (for example, the acknowledgement packet) received at 220 from the server 105, in accordance with some example embodiments. As noted, the gateway 110A may provide the encrypted acknowledgement response/reply from the server 105 in an advertisement response message as well. At 242, the gateway 110A may stop sending advertisements/responses, in accordance with some example embodiments.

At 250, the IoT sensor 115A may validate the acknowledgement included in the scan response (at 240) and/or advertisement (at 237), in accordance with some example embodiments. For example, if the acknowledgment indicates the server 105 successfully received the encrypted payload sent at 203-204 by the IoT sensor 115A, the IoT sensor may mark the data sent at 203 as successfully sent. To illustrate further, if the sensor can properly decrypt the reply from the server or the content of the reply is a proper response to a challenge, the sensor may validate the acknowledgement included in the scan response (at 240) and/or advertisement (at 230). Moreover, the IoT sensor may provide a user indication such as a message or visual indication that the transmission at 203-204 was successfully received by the cloud server 105. When this is the case, the IoT sensor 115A may then stop, at 252, Bluetooth related scanning, in accordance with some example embodiments (at least until additional data such as a new measurement needs to be sent to the server 105 as noted at 202 above).

Referring again to FIG. 1, the gateway 110A may, in some example embodiments, provide a rate limit to the data being passed via the gateway (from a single sensor 115A, from set of devices 115A-F, to a specific URL or some URLs), in order to guard against DoS attacks.

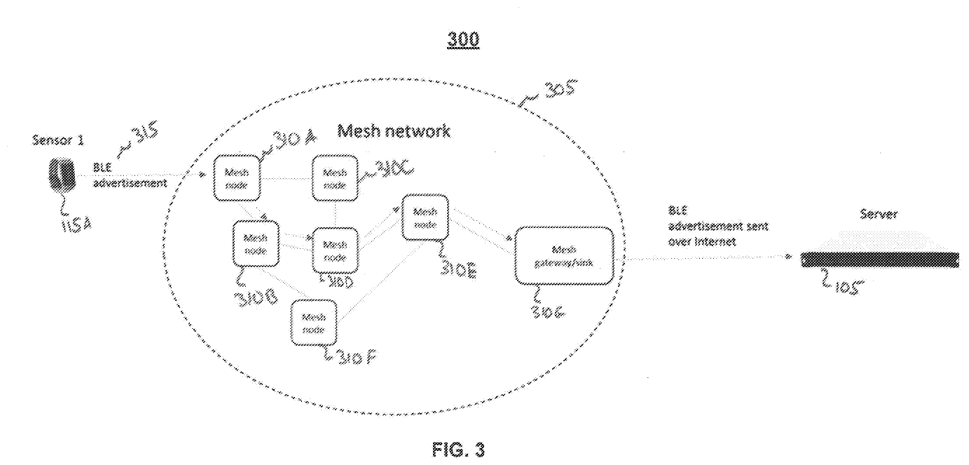

FIG. 3 depicts a system 300 including at least one IoT sensor such as IoT sensor 115A, a mesh network 305, and a server such as server 105, in accordance with some example embodiments. The mesh network 305 may include a plurality of mesh nodes 310A-G including at least one mesh node 310G that operates as an IOT gateway interfacing the Internet accessible IoT cloud server 105. In the example of FIG. 3, the gateway 310G may listen to Bluetooth LE advertisements such as advertisement 315, which may be emitted by sensor 115A and/or forwarded by the other mesh nodes 310A-F. In this example, the mesh nodes 310A-F forward the received advertisement 315 through the mesh network 305 until it arrives at the gateway 310G. The gateway 310G may then post the encrypted payload of advertisement 315 to the server 105, as described above at 204, for example.

In some example embodiments, the one or more of the mesh nodes receiving BLE advertisements 315 may detect duplicates. For example, if the mesh network provides reliable delivery from 310A to 310G, the mesh node 310A may detect duplicate advertisements and may only send message 315 once towards mesh node 310G. Alternatively or additionally, the one or more of the mesh nodes receiving BLE advertisements 315 may detect if the BLE advertisement is of interest. For example, the mesh node 310A may decide to forward only those advertisements that indicate the identity of server 105 that is supported. Alternatively or additionally, the one or more of the mesh nodes receiving BLE advertisements 315 may remain agnostic with respect to BLE advertisement content, in which case the mesh node 210A may forward everything to mesh node 310G (or utilize some filtering as noted above as the mesh nodes 310A-F may not need to understand the idea of URLs and encrypted payloads as disclosed herein). Alternatively or additionally, the mesh gateway 310G may forward a reply from the server to only to the mesh node that the mesh gateway last heard from (for example, 310E in the example of FIG. 3). Alternatively or additionally, the edge of mesh network, such as mesh node 310A, may attempt to communicate the cloud server's reply messages to IoT sensor 115A from time or some time, and may report to mesh gateway 310G the successful delivery or unsuccessfully delivery of the reply (or, for example, timeout). This enables 310G to not burden mesh with retransmissions unless really needed (310A timeouts transmissions to 115A). When unsuccessful, the mesh gateway 310G may ask another mesh node to forward the cloud server's reply to IoT sensor 115A.

In some example embodiments, the IoT sensor may use broadcast transmissions of advertisements in order to provide data to other devices such as a cloud server. In this way, the IoT sensor may be configured to not establish a connection to the gateway, but instead use the broadcast of the advertisements. By reducing the need for the IoT sensor to establish connections, the IoT sensor may be simplified, saving power etc. Moreover, the use of the advertisements as disclosed herein may reduce (or eliminate) the need to require the IoT sensor and gateway to be paired.

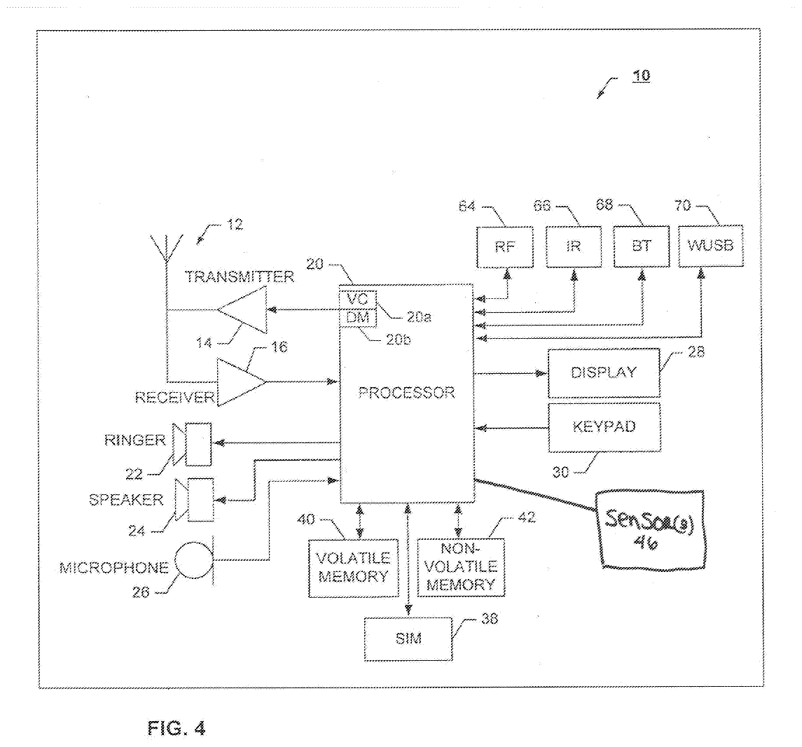

FIG. 4 illustrates a block diagram of an apparatus 10, in accordance with some example embodiments. The apparatus 10 (or portions thereof) may be configured to provide at least the IoT sensor's wireless transceiver for example, although the apparatus 10 may also provide the IoT gateway as well.

In some example embodiments, the apparatus may include one or more sensors 46, such as temperature, acceleration, humidity, pressure, magnetometer, weight, CO2, carbon monoxide, smoke, movement, motion, heat rate, electrocardiogram, perspiration, and/or any other type of sensor.

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 4 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 4, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations disclosed herein. The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In the example embodiment, the processor 20 may be configured using computer code stored at memory 40 and/or 42 to control and/or provide one or more aspects disclosed herein (see, for example, process 200).

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 4, computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein is that the sensor may never need to connect to a gateway or mesh network as it can send data via the broadcast of advertisements, may reduce the burden of provisioning, deployment, and/or mobility associated with a IoT sensor.

Without in any way limiting the scope, interpretation, or application of the claims appearing below, a technical effect of one or more of the example embodiments disclosed herein is that there may be no need to pair the sensor device with a gateway.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

1-63. (canceled)

64. A method comprising:
sending an advertisement including a payload and an indicator identifying a server, the payload including data collected, generated, and/or measured by a sensor;
receiving, from a gateway and the server, a reply including server data; and
inhibiting, based on the received reply, the advertisement including the payload from being resent.

65. The method of claim 64 further comprising:
receiving, from the gateway, a scan request; and
in response to the received scan request, scanning for the reply being resent by the gateway.

66. The method of claim 64, wherein the data from the payload includes an identifier of the apparatus and/or a challenge for the server.

67. The method of claim 64, wherein the indicator comprises a location of the server, an address of the server, a fully qualified domain name of the server, an internet protocol address of the server, and/or a uniform resource locator of the server.

68. The method of claim 64 further comprising:
resending the advertisement until the reply including the server data authenticates the server, wherein the advertisement comprises a Bluetooth advertisement, a Bluetooth low energy advertisement, a Bluetooth scan response, and/or a Bluetooth low energy scan response.

69. The method of claim 64, wherein the advertisement is sent as a broadcast and/or a multicast to the gateway via at least a Bluetooth transceiver and/or Bluetooth low energy transceiver.

70. The method of claim 64, wherein the payload is encrypted, and wherein the server data included in the reply is encrypted.

71. The method of claim 64 further comprising:
marking, in response to the received reply, the data as being successfully sent to the server.

72. The method of claim 64 further comprising:
validating the received reply based on a decryption of the payload and/or a content of the payload; and
in response to the validating, inhibiting the advertisement including the payload from being resent by the sensor.

73. The method of claim 64, wherein the server comprises a cloud server.

74. The method of claim 64, wherein the sensor comprises an internet of things sensor performing the method.

75. The method of claim 64, wherein the advertisement is sent to a mesh network including the gateway.

76. A method comprising:
receiving, from a gateway, a message including a payload, the payload including data collected, generated, and/or measured by a sensor;
generating a reply including server data to enable the sensor to inhibit, based on the reply, retransmission of the advertisement including the payload; and
sending, to the gateway, the generated reply.

77. The method of claim 76 further comprising:
receiving the message as a hypertext transfer protocol post and/or a hypertext transfer protocol secure post.

78. The method of claim 76, wherein the generating further comprises determining a response to a challenge provided by the sensor via the payload.

79. The method of claim 76, wherein the payload is encrypted, and wherein the determined response to the challenge is included in the reply and encrypted.

80. The method of claim 76, wherein an apparatus comprising a cloud server performs the method, and wherein the sensor is an internet of things sensor including a Bluetooth transceiver and/or a Bluetooth low energy transceiver enabling transmission the payload to the apparatus via a gateway.

81. An apparatus comprising:
at least one processor; and
at least one memory including program code which when executed causes the apparatus to at least:
send an advertisement including a payload and an indicator identifying a server, the payload including data collected, generated, and/or measured by the apparatus;
receive, from a gateway and the server, a reply including server data; and
inhibit, based on the received reply, the advertisement including the payload from being resent.

82. The apparatus of claim 81, wherein the apparatus is further caused to at least receive, from the gateway, a scan request, and in response to the received scan request, scan for the reply being resent by the gateway.

83. The apparatus of claim 64, wherein the data from the payload includes an identifier of the apparatus and/or a challenge for the server.
